(19) United States
(12) Patent Application Publication
(10) Pub. No.: US 2025/0280843 A1
(43) Pub. Date: Sep. 11, 2025

(54) METHOD FOR INHIBITING POTATOES FROM GREENING AND USE THEREOF

(71) Applicant: Zhejiang Wanli University, Ningbo (CN)

(72) Inventors: Zhenfeng YANG, Ningbo (CN); Liyu SHI, Ningbo (CN); Shifeng CAO, Ningbo (CN); Jiaxin WANG, Ningbo (CN); Wei CHEN, Ningbo (CN); Saisai LI, Ningbo (CN); Yabing FENG, Ningbo (CN); Wei WU, Ningbo (CN)

(21) Appl. No.: 18/824,667

(22) Filed: Sep. 4, 2024

(30) Foreign Application Priority Data
Mar. 11, 2024 (CN) 2024102758953

(51) Int. Cl. A23B 7/152; A01N 3/00

(52) U.S. Cl. CPC A23B 7/152; A01N 3/00

(57) ABSTRACT

A method for inhibiting potatoes from greening and use thereof, which can effectively inhibit potatoes from post-harvest greening and production of solanine. The use of 1-MCP for inhibiting potatoes from greening significantly delays the post-harvest greening progress of the potatoes and is of great significance for storage and quality maintenance of potatoes. 1-MCP can inhibit the expression of key genes in the solanine synthesis pathway, inhibit the expression of key genes in the chlorophyll synthesis pathway, promote the expression of chlorophyll degradation genes. It does not affect the expression of germination-promoting genes. 1-MCP can inhibit greening without affecting potato germination, and the potatoes will not be greened even if they sprout. NaOH and 1-MCP are employed synergistically for fumigation to significantly improve the effect of 1-MCP in inhibiting potatoes from greening.

### CROSS-REFERENCE TO RELATED APPLICATIONS

The present application claims the priority of a Chinese prior application No. 2024102758953 filed on Mar. 11, 2024, and all contents of the prior application, including but not limited to the specification, drawings, claims and abstract, are incorporated in their entirety as a part of the present application.

### BACKGROUND OF THE INVENTION

### Field of the Invention

The present invention belongs to the field of potato pretreatment, and particularly relates to a method for inhibiting potatoes from greening and use thereof.

### Description of the Related Art

Potatoes are the fourth largest food crop in the world. Their tubers are nutritious, rich in starch, protein, saccharides and the like. However, during storage, greening of potatoes can occur due to the influence of illumination. The greened potatoes will produce solanine, a highly toxic glycoalkaloid, which seriously affects their commodity value and causes huge economic losses. It is an urgent problem to ensure the edible safety of potatoes, control their quality, and prevent the potatoes from greening.

The greening of potatoes is mainly caused by illumination. Storing with protection from light can delay the greening of potatoes, but it is difficult to achieve complete lightlessness in the potato sales market. Therefore, in order to solve this problem, it is crucial to find an effective method capable of preventing post-harvest greening of potatoes without storage in the dark.

Currently, storage at low temperature and with protection from light is an effective method to delay the post-harvest greening of potatoes. However, storage at low temperature will generate many negative effects. Long-term low temperature will cause saccharification of potato tubers, seriously affect their processing quality, and also increase potential carcinogens such as acrylamide, which is not conducive to the development of the potato deep processing industry. Reducing or avoiding light irradiation on the surfaces of potatoes has a good anti-greening effect. Retaining the soil on the surfaces of the tubers is the most direct means to effectively reduce the possibility of greening. However, this will lead to lower visual acceptance of the commodity product among consumers, reducing the likelihood of purchasing it, and it will also be difficult for consumers to store it with protection from light for a long term after purchase.

Previous post-harvest research on potatoes has mainly focused on the direction of inhibiting germination, with few studies focused on the direction of potato greening. AU2020447210A1 provides a method for storing potatoes, which includes first pickling the potatoes, then treating the pickled potatoes with 1-methylcyclopropene, and storing them in the range of 6-15° C., which can effectively inhibit potatoes from germination. This method requires the potatoes to be pickled before treatment with 1-methylcyclopropene, and has definite requirements for storage temperature. It can only inhibit the potatoes from germination, and has not studied whether it can inhibit the potatoes from greening and toxin production.

Therefore, it is urgent to find a simpler method that can effectively prevent potatoes from greening and toxin production.

### BRIEF SUMMARY OF THE INVENTION

In order to solve the aforementioned problems, the present invention provides a method for inhibiting potatoes from greening and use thereof. By directly treating the potatoes with a reagent containing 1-methylcyclopropene (1-MCP), the potatoes can be effectively prevented from greening or production of solanine, and the shelf life is up to more than 6 months. The method is easy to operate and low in cost. With this method, the germination of the potatoes can also be delayed, and even if the potatoes germinate, no solanine is produced in the potatoes, so that they can still be eaten safely. Therefore, the potatoes can be stored and transported at room temperature and without protection from light, significantly delaying greening and extending the shelf life. It brings great convenience to the production and sales of potatoes, effectively improves the commodity value, and prevents waste of resources.

In an aspect, the present invention provides a method for inhibiting potatoes from greening. The method treats the potatoes with a reagent containing 1-methylcyclopropene, thereby delaying or inhibiting the potatoes from greening. In some embodiments, it is possible to delay the greening of the potatoes under a condition of illumination for a delay time of 6-8 months.

1-MCP is a very effective inhibitor of ethylene production and ethylene action. Ethylene, as a plant hormone that promotes maturity and aging, can be produced by some plants themselves and exists in a certain amount in the storage environment and even in the air. Ethylene binds with a related receptor inside a cell to activate a series of physiological and biochemical reactions related to maturity, thereby accelerating aging and death. 1-MCP can also bind well with an ethylene receptor, but such binding will not cause a biochemical reaction of maturity. Therefore, before the production of endogenous ethylene in a plant or the action of exogenous ethylene, if 1-MCP is applied, it will bind with the ethylene receptor first, thereby preventing the binding of ethylene with the receptor thereof, which greatly prolongs the ripening and aging process of fruits and vegetables and extends the length for preservation. There are many reagents that bind with the ethylene receptor to control the production of ethylene, e.g. aminooxyacetic acid (AOA), salicylic acid (SA), 2,5-norbornadiene (2,5-NBD), silver thiosulfate (STS), and aminooxyvinylglycine (AVG). These reagents are all ethylene inhibitors. The team of the present invention also employs the aforementioned reagents to treat potatoes, hoping to find a useful reagent that can prevent the potatoes from greening even under illumination. The results are not ideal. These reagents will not inhibit the potatoes from greening, and some of them instead accelerate the greening progress, e.g. salicylic acid (SA) and 2.5-norbornadiene (2,5-NBD) (with specific experimental data omitted). Therefore, the researchers in the team of the present invention have surprisingly found that 1-MCP can significantly inhibit potatoes from greening and can also delay potatoes from germination.

1-methylcyclopropene, abbreviated as 1-MCP, with properties that: at room temperature, 1-MCP is a gas and a small cycloolefin with very active properties. It has a molecular weight of 54.09. It has water solubility (20° C.) of 137 mg/L; density of 2.24 g/L at 20° C.; solubility in terms of a solvent with solubility (g/L): heptane 2.5; xylene 2.3; ethyl acetate 12.5; methanol 11.25; acetone 2.4; 3-dichlorotoluene 2.0; a gas pressure at 25° C.: 2×10 Pa; an octanol-water separation coefficient: log Kow=2.4; UV-visible absorption spectrum: 205 nm, with no maximum absorption spectrum above; a CAS registration number of 3100-04-7; and an OPP chemical number of 224459. Its chemical structure is as follows:

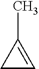

Therefore, we believe that the greening and production of solanine of the potatoes are not caused by their maturity and aging, and are independent of a preservation mechanism. Instead, it is because that the chlorophyll accumulates on the exposed skin of the harvested potatoes under the influence of illumination factors. This process is accompanied by the production of highly toxic glycoalkaloids (solanine).

Further, the reagent containing 1-methylcyclopropene contains NaOH, and the treatment method is fumigation.

In another aspect, the present invention provides use of 1-methylcyclopropene for preparing a reagent for inhibiting potatoes from greening.

In a further aspect, the present invention provides use of 1-methylcyclopropene for preparing a reagent for inhibiting potatoes from production of solanine.

Further, the potatoes will sprout first, but will not be greened and will not produce solanine.

In a further aspect, the present invention provides use of 1-methylcyclopropene in preparation of a reagent for preventing potatoes from producing solanine even when they sprout.

In a further aspect, the present invention provides use of 1-methylcyclopropene in preparation of a reagent for preventing potatoes from greening even when they sprout.

In a further aspect, the present invention provides use of 1-methylcyclopropene in preparation of a reagent for inhibiting potatoes from synthesizing chlorophyll.

In a further aspect, the present invention provides use of 1-methylcyclopropene in preparation of a reagent for inhibiting the expression of chlorophyll synthesis-related genes in potatoes, where the chlorophyll synthesis-related genes include any one or more of StHEMA (XM_006364910), StGSA (XM_006359237.2), StPBGD (XM_006345976.2), StCPO (XM_006352558.2), StPPO (NM_001288295.1), StCHLD (XM_006350150.2), StCHLI (XM_006360998.2), StCHLH (XM_006350126.2), StCHLM (XM_006341414.2), StCRD1 (XM_006364694.2), StPOR1 (XM_006358921.2), StPOR2 (XM_006362887.2), StCHLG (XM_049522753.1), and StCHLP (XM_006364530.2).

In a further aspect, the present invention provides use of 1-methylcyclopropene in preparation of a reagent for promoting the expression of chlorophyll degradation-related genes in potatoes, where the chlorophyll degradation-related genes include any one or more of StSGR (XM_006348493.2), StNYC1 (XM_006360411.2), StTIC (XM_006361237.2), and StPAO (XM_006348126.2).

In a further aspect, the present invention provides use of 1-methylcyclopropene in preparation of a reagent for inhibiting the expression of solanine synthesis-related genes in potatoes, where the solanine synthesis-related genes include any one or more of StHMGR (XM_015304124.1), StPSS1 (XM_006361944.2), StSQE1 (XM_006364340.2), StCAS1 (XM_006362746.2), StSSR2 (XM_006352987.2), StSSR1 (XM_006363578.2), StPGA2 (XM_006361107.2), StPGA1 (XM_006361108.2), StDOX (XM_006357818.2), StGAME6 (XM_006357819.2), StPGA3 (XM_006351919.2), StGAME12 (XM_006351918.2), StSGT1 (NM_001318679.1), StSGT2 (XM_006352780.2), and StSGT3 (HM188447.1).

The numbers in brackets after the aforementioned gene names are corresponding gene serial numbers, and specific sequences can be found in the NCBI database.

The present invention has the following beneficial effects,
1. A brand new method for inhibiting potatoes from greening is provided, which can effectively inhibit the potatoes from post-harvest greening and production of solanine.
2. The use of 1-MCP for inhibiting the potatoes from greening has been discovered. After being treated with 1-MCP, the potatoes are stored at room temperature in the light, which significantly delays the greening progress and production of solanine compared with the control group. Therefore, the present method significantly delays the greening progress of the potatoes after harvest, which is of great significance for the storage and quality maintenance of potatoes in the future.
3. It has been found that 1-MCP can inhibit the expression of key genes in the solanine synthesis pathway, inhibit the expression of key genes in the chlorophyll synthesis pathway, promote the expression of chlorophyll degradation genes, and meanwhile does not affect the expression of germination-promoting genes. 1-MCP can inhibit greening without affecting potato germination, and even if potatoes sprout, they will not be greened.
4. The fumigation is carried out with NaOH and 1-MCP synergistically, which significantly improves the effect of 1-MCP in inhibiting potato greening.
5. The treatment reagent 1-MCP is inexpensive and will not significantly increase the cost when used for treating potatoes. It meanwhile has an excellent treatment effect and is of great significance to the post-harvest storage of potatoes.

### BRIEF DESCRIPTION OF THE DRAWINGS

FIG. 1 is a schematic diagram showing a trend of change in the degree of greening of potatoes in a group treated with 1-MCP and a control group during storage in Example 1;

FIG. 2 is a schematic diagram of the change in chlorophyll content of potatoes in the group treated with 1-MCP and the control group during storage in Example 1;

FIG. 3 is a schematic diagram showing the change in ethylene release of potatoes in the group treated with 1-MCP and the control group during storage in Example 1;

FIG. 4 is a schematic diagram showing the change in contents of solanine, α-solanine and α-chaconine in potatoes in the group treated with 1-MCP and the control group during storage in Example 1;

FIG. 5 is a schematic diagram showing a trend of change in the degree of greening of potatoes in the group treated with 1-MCP and the control group during long-term storage in Example 1;

FIGS. 6A-1 through 6A-3, 6B-1 through 6B-3, 6C-1 through 6C-3, 6D-1 through 6D-3, and 6E-1 through 6E-3 are schematic diagrams showing the change in expression amount of 15 key genes in the solanine synthesis pathway of potatoes in a group treated with 1-MCP and a control group during storage in Example 2;

FIGS. 7A-1 through 7A-3, 7B-1 through 7B-3, 7C-1 through 7C-3, 7D-1 through 7D-3, 7E-1 through 7E-3, and 7F-1 through 7F-3 are schematic diagrams showing the change in expression amount of 18 key genes in the chlorophyll synthesis pathway of and degradation genes of potatoes in the group treated with 1-MCP and the control group during storage in Example 2;

FIG. 8 is a schematic diagram showing the change in expression amount of germination-promoting genes in potatoes in the group treated with 1-MCP and the control group during storage in Example 2; and

FIG. 9 is a schematic diagram showing the change in the greening index a* of potatoes vs fumigation agents in Example 3.

### DETAILED DESCRIPTION OF THE INVENTION

The preferred embodiments of the present invention will be described in further detail below in conjunction with the accompanying drawings. It should be noted that the following embodiments are intended to facilitate the understanding of the present invention and are not intended to limit it in any way. All features disclosed in the embodiments of the present invention, or all steps of the disclosed methods or processes except mutually exclusive features and/or steps, can be combined in any way.

### Example 1: Fumigation of Potatoes with 1-MCP

The method for inhibiting potatoes from greening was: treating potato tubers with 1-MCP, and specifically, fumigating potato tubers with 1-MCP and NaOH.

“V7” potatoes were used as experimental materials. They were collected from Dongyu Vegetable Market in Ningbo City, Zhejiang Province. They were freshly picked and transported to the laboratory at room temperature. They were cleaned, and tubers of uniform sizes and free of diseases and insect pests and free of mechanical damages were selected as experimental samples. The samples were divided into two groups, immersed in distilled water for 10 min and then naturally air-dried after the immersion treatment was ended.

One group served as a control group (CK) without any subsequent treatment, and contained 50 potatoes. For another group, a carton was provided, in which 50 potatoes were placed. The carton was placed in a controlled atmosphere storage box with a volume of 1,000 L at a temperature controlled at 25° C. and the humidity maintained at 60%. The gas composition in the controlled atmosphere storage box was maintained the same as that of the atmosphere. A space was reserved in the controlled atmosphere storage box. 10 mg of 1-MCP dry powder was weighed into a glass weighing bottle. The weighing bottle containing 1-mcp was placed in the controlled atmosphere storage box, and added with 2 ml of a 1M NaOH solution to release 1-mcp gas from the weighing bottle. The weight of the gas was 10 mg. The potatoes were placed in the gas environment, fumigated for 16 h, taken out and then air-dried for 1 h. The meaning of “fumigation” here was to put the potatoes in a gas environment of 10 mg 1-mcp in a 1,000 L controlled atmosphere storage box, which was equivalent to a concentration of 0.01 milligrams of the 1-mcp gas per liter of gas.

Subsequently, the potatoes of the control group (2 groups) and the treatment group (2 groups) were bagged (two groups). The two groups were stored in a constant temperature and humidity chamber at 25±1° C. and relative humidity of 60% for 12 d. One of the groups was an illumination group with an illumination intensity of 10,000 LUX, and the other one was a group with protection from light having an illumination intensity of 0 LUX (in the dark). The tuber skin of the potatoes was taken every 3 d and photographed. The skin was then frozen in liquid nitrogen, and stored at −80° C. for subsequent analysis.

### 1. Determination of Greening Index

Potato tubers treated for corresponding days were picked out. 6 potatoes were randomly selected from each group. the skin of potato tuber was peeled off, and immediately measured for the color difference with a colorimeter (Shenzhen ThreeNH Technology Co., Ltd., model: NR60CP+), and the a* value was determined and recorded with a CR-400 colorimeter to indicate the color change of the potato skin. a* was an important parameter for measuring color and lustre. The positive or negative value indicated reddish (positive indicated reddish) or greenish (negative indicated greenish), and the magnitude of the absolute value indicated the degree of reddish or greenish. The colorimeter was calibrated with a standard white plate before determination.

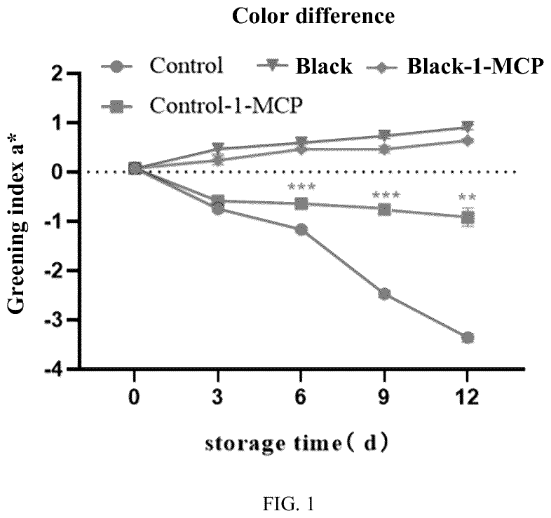

FIG. 1 showed a trend of change in the degree of greening of potatoes in a group treated with 1-MCP and a control group during storage. On the 6th day of storage, in a dark environment, the control was in the same trend as that of the 1-MCP treatment, with basically no greening and a slightly reddish color difference, but the progress was slow and there was no significant difference. However, under illumination conditions, the greening index a* of the control group dropped sharply, while the a* of the group treated with 1-MCP still remained at a relatively high level, showing extremely significant difference from that of the control on the 6th and 9th days (with p less than 0.001) and showing significant difference from that of the control on the 12th day.

### 2. Determination of Chlorophyll Content

0.2 g of a potato frozen sample (the sample of the illumination group) was taken, grounded into a homogenate with 1.5 mL of 95% (v/v) ethanol in an ice bath, and then centrifuged at a rotational speed of 10.000 r/min for 10 min. The precipitate was discarded, the supernatant was taken, and 95% ethanol was used as a blank group, to determine the absorbance values at 649 nm and 665 nm, respectively. The chlorophyll content was expressed in mg/g FW.

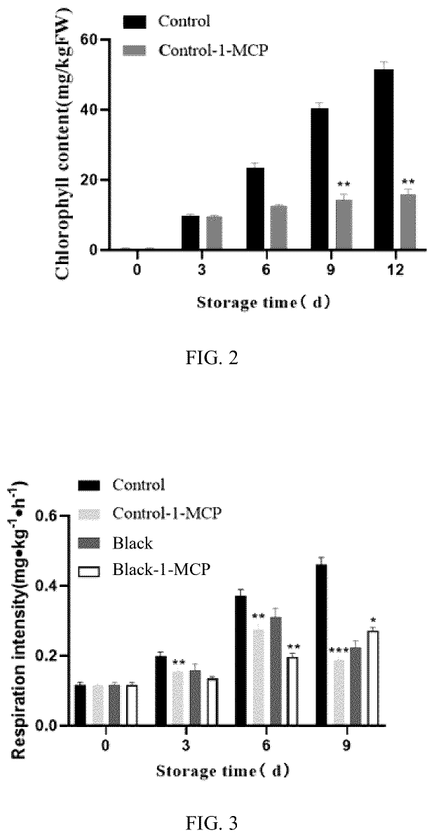

FIG. 2 showed the change in chlorophyll content in the group treated with 1-MCP and the control group during storage. During storage, the chlorophyll content in the control group increased sharply, while the chlorophyll content in the group treated with 1-MCP increased slowly compared with the control group, with a significant difference, indicating that the greening progress of potato tubers treated with 1-MCP was delayed.

### 3. Determination of Ethylene Release Amount

4 potato tubers were randomly selected and placed in a sealed container (illumination group). They were placed at respective storage temperatures for 3 h, and then 5 mL of gas was extracted and determined for ethylene content using a Shimadzu type 2014C gas chromatograph (Shimadzu, Japan). At the same time, standard ethylene gas was used as a standard curve to calculate the ethylene release rate of the fruit.

FIG. 3 showed the change in ethylene release amount. During storage, the ethylene release amount of the control group gradually increased, and the release amount increased sharply during the 9-12th days, while the ethylene release amount of the group treated with 1-MCP remained in a certain range until the 12th day when it began to increase, and was always lower than that of the control group during the entire storage period.

### 4. Determination of Solanine Content (Illumination Group and Dark Group)

Solanine was mainly composed of solanine and chaconine, with solanidine as aglycone. Therefore, α-solanine and α-chaconine (Sigma-Aldrich, USA) were used as chemical standards for quantification of SGA content.
1) Liquid chromatography conditions: AgilentEclipsePlusC18 chromatographic column (100 mm×2.1 mm, 1.8 μm); the mobile phase A was 1 mmol/L of an acidified ammonium formate solution, and the mobile phase B was acetonitrile. Gradient elution: 90% A for 0.0-4.0 min; 10% A for 4.0-5.0 min; and 90% A for 5.0-7.0 min. The flow rate was 0.4 mL/min; the column temperature was 40° C., and the injection volume was 5 μL.
2) Mass spectrometry conditions: electrospray ionization positive ion mode, with an electrospray voltage of 4,000 V, an ion source temperature of 350° C., and a nebulizer pressure of 20 psi.
3) Formulation of standard curve solution: each 1 mg of α-solanine and α-chaconine was weighed into a 1.5 mL centrifuge tube, dissolved with methanol and fixed to a volume to formulate a 1 mg/mL standard stock solution; and the standard stock solution was diluted with methanol stepwise to prepare a series of mixed standard solutions of 0.1, 0.2, 0.5, 1, 2, 5, and 10 ug/mL.

4) Sample pretreatment: the sample was fully broken up and mixed with a homogenizer, placed into sub-packaging containers, sealed and labeled, and frozen-stored below −20° C. 1.0 g (accurate to 0.001 g) of the specimen was weighed into a 50 mL stoppered centrifuge tube, added with 3.0 mL of water and well mixed by vortexing for 1 min, then accurately added with 25.0 mL of acidified methanol (1% formic acid+99% methanol) and vortexed for 1 min. Thereafter, 2.0 g of anhydrous sodium sulfate and 1.0 g of anhydrous magnesium acetate were added into the centrifuge tube. The centrifuge tube was shaken vigorously by hand for 1 min and then vortexed for 1 min. Then, the centrifuge tube was placed in a centrifuge and centrifuged at a speed of 10,000 r/min under conditions of room temperature for 5 min. 50 μL of the supernatant was taken and placed into a 10 mL volumetric flask, added with a methanol aqueous solution (40% methanol) to fix the volume to the scale, passed through a microporous filter membrane (0.22 μm, nylon) and then determined on the machine.
5) Qualitative and quantitative methods: α-solanine and α-chaconine were qualitatively determined by retention times, and α-solanine and α-chaconine were quantitatively analyzed by an external standard method.

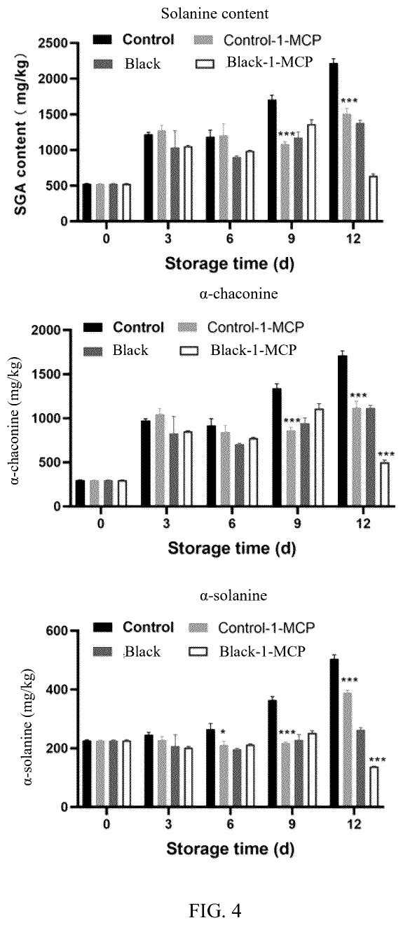

FIG. 4 showed the contents of solanine, α-solanine and α-chaconine. During storage, the solanine content in the control group increased sharply, while the solanine content in the group treatment with 1-MCP increased very slowly regardless of whether it was stored at night or in natural light. At the same time, the α-solanine and α-chaconine contents in the group treatment with 1-MCP were significantly different from those in the control group starting from the 3rd day. This indicated that 1-MCP treatment could significantly reduce the solanine content in potato tubers or inhibit the reduction of solanine, and its effect could be directly comparable to the effect of storage with protection from light.

### 5. Long-Term Preservation Effect

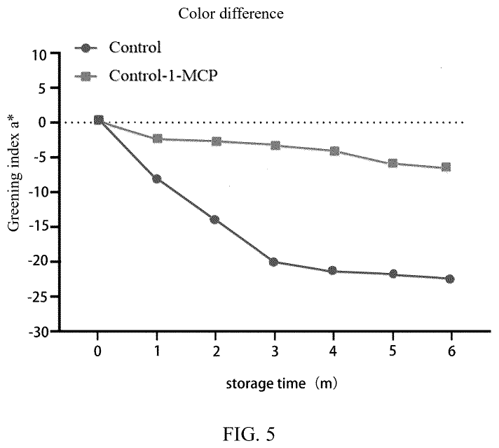

In order to simulate natural illumination, the aforementioned control and treated potatoes were placed in an incubator (fully transparent), and placed under conditions of 25±1° C. and relative humidity of 60% in an outdoor environment. Based on the environment with natural alternation of day and night, the color difference was calculated through instruments. The change in color difference values was measured every 5 days during storage for 2, 3, and 6 months. The results were shown in FIG. 5. The results were that the color difference values of the treatment group (although the absolute values were getting bigger and bigger) were still significantly different from those of the control group. In the 2nd month of storage, the color difference value of the control group was −14, while the test value of the treatment group was −2.2. From the perspective of appearance, obvious green spots occurred in the control group, while the treatment group had no obvious changes. Upon 3 months of storage, the control group had serious greening and germination and had to be discarded, while the treatment group had a small amount of germination in appearance, but had no occurrence of greening, with the color difference value being still remained at −3.4. Upon 6 months of storage, the treatment group had a small amount of germination, but it still had no occurrence of greening, with the color difference value being still remained at −6.7 and also the solanine content being still maintained within a safe range, and thus the potatoes could still be eaten safely.

Chlorophyll content was an important indicator for measuring potato greening. During the greening process of potatoes, the solanine content would increase, causing the accumulation of toxic substances, while the ethylene release amount represented the maturity of potato tubers. In summary, treatment with 1-MCP could inhibit the greening of potatoes, and 1-MCP did not inhibit the maturity of potatoes, and greening would not occur even if the potatoes sprouted.

### Example 2: Determination of Gene Expression

Genes related to inhibition of solanine synthesis included StHMGR, StPSS1, StSQE1, StCAS1, StSSR2, StSSR1, StPGA2, StPGA1, StDOX, StGAME6, StPGA3, StGAME12, StSGT1, StSGT2, and StSGT3.

Chlorophyll synthesis-related genes included StHEMA, StGSA, StPBGD, StCPO, StPPO, StCHLD, StCHLI, StCHLH, STCHLHM, StCRD1, StPOR1, StPOR2, StCHLG, and StCHLP.

Chlorophyll degradation-related genes included StSGR, StNYC1, StTIC, and StPAO.

Germination-promoting genes included StPOD42 (XM_006363284.2).

Except for StPOD42, the serial numbers of the aforementioned genes had been noted in the Summary section, and the specific sequences could be found in the NCBI database.

Total RNA was extracted from frozen potato skins and transformed into cDNA. The expression levels of the aforementioned genes were determined by a Bio-Rad CFX 96 Real-Time PCR System (BIO-RAD, Hercules, CA, USA) and a SYBR Green I Master Mix (Vazyme, Nanjing, Jiangsu, China). Thermocycling conditions included an initial denaturation step at 95° C. for 30 s, followed by 39 cycles of 95° C. for 15 s, then 55° C. for 30 s, and 72° C. for 20 s. Three biological replicates were used, and each replicate was measured for three times. StEF-1a was used as a reference gene for potatoes. Gene expression was calculated by using a 2-ΔCt method.

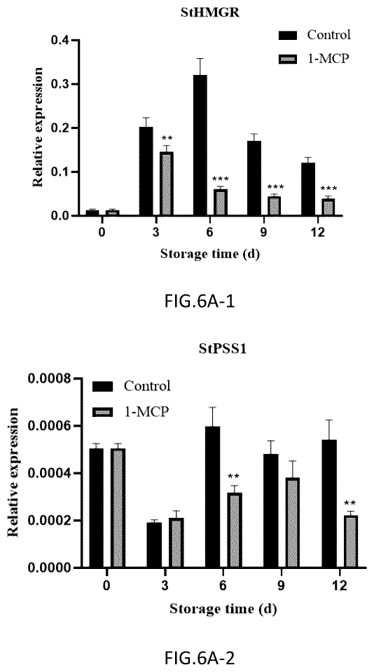

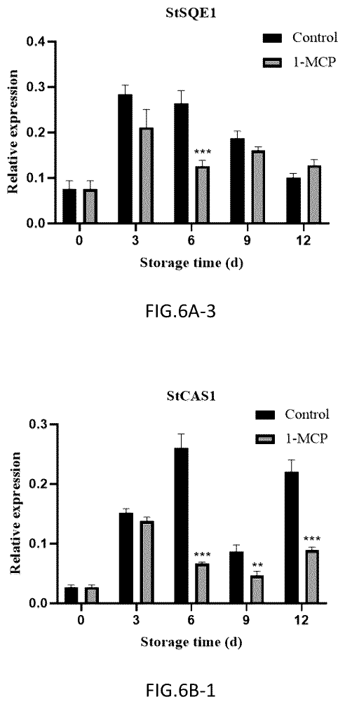

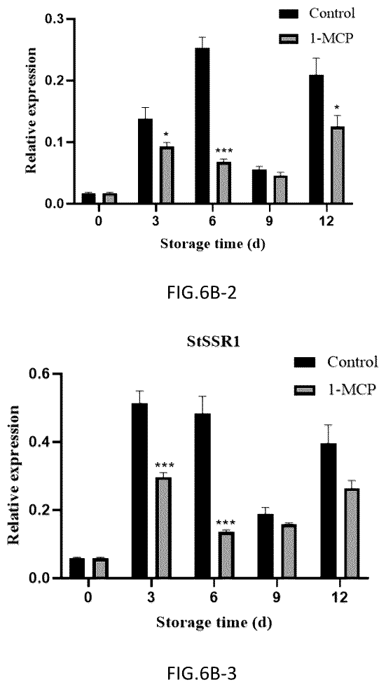

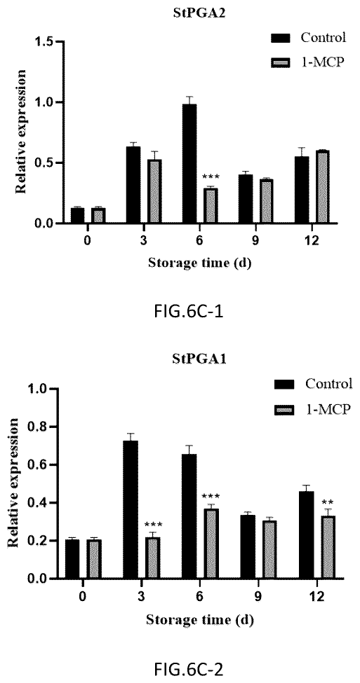

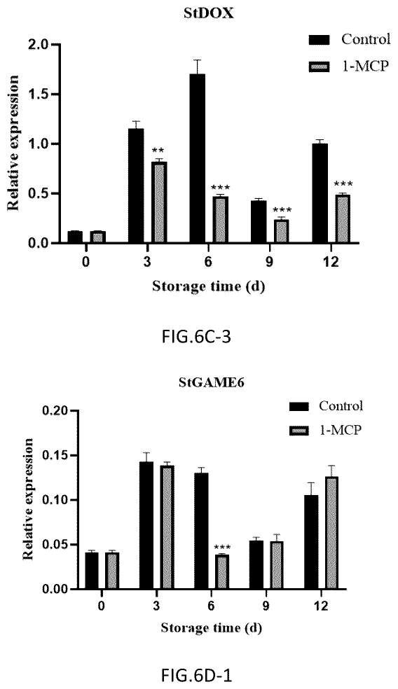

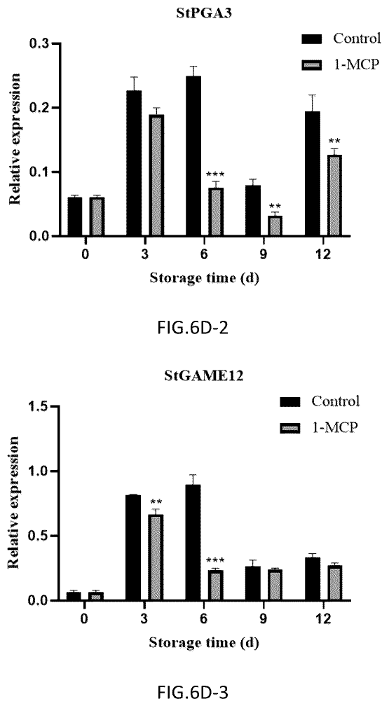

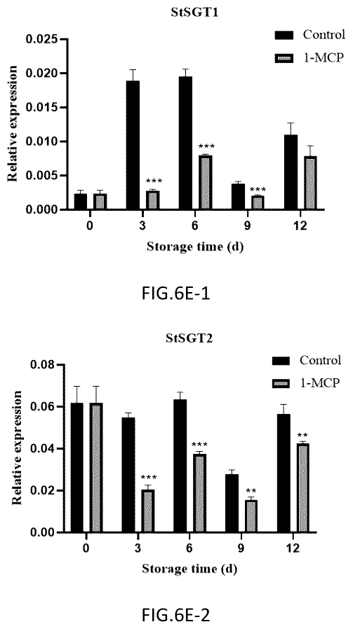

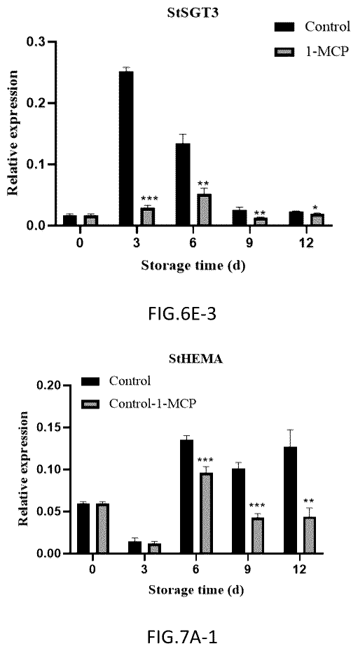

FIGS. 6A-1 through 6A-3, 6B-1 through 6B-3, 6C-1 through 6C-3, 6D-1 through 6D-3, and 6E-1 through 6E-3 showed the expression amount of key genes in the solanine synthesis pathway analyzed by real-time fluorescence quantitative PCR. It could be seen through analysis that the solanine-related genes in the group treatment with 1-MCP during the greening period were significantly different from those in the control group, and the expression amount was significantly lower than those in the control group. This revealed a mechanism by which 1-MCP treatment inhibited greening, namely, inhibiting the expression of solanine synthesis-related genes.

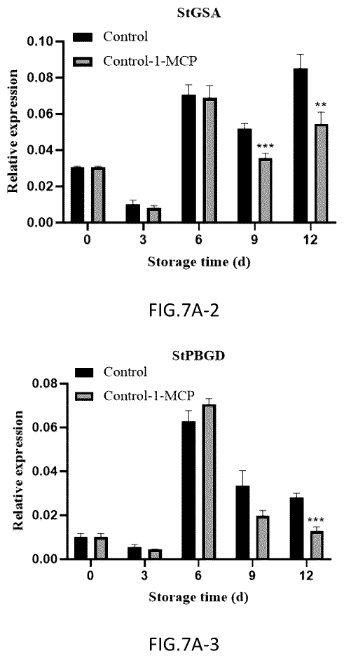

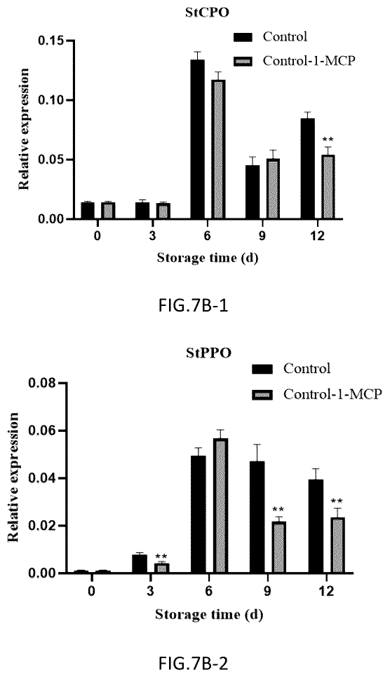

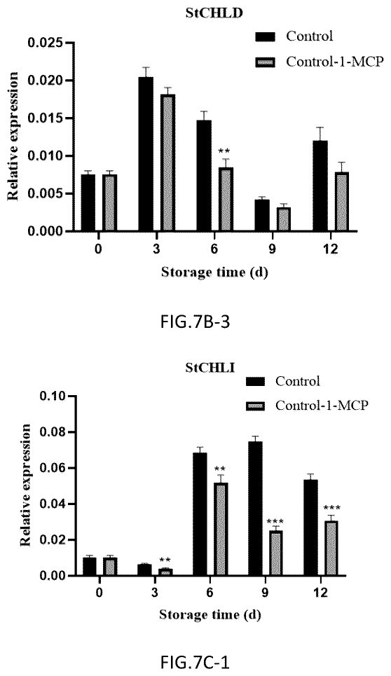

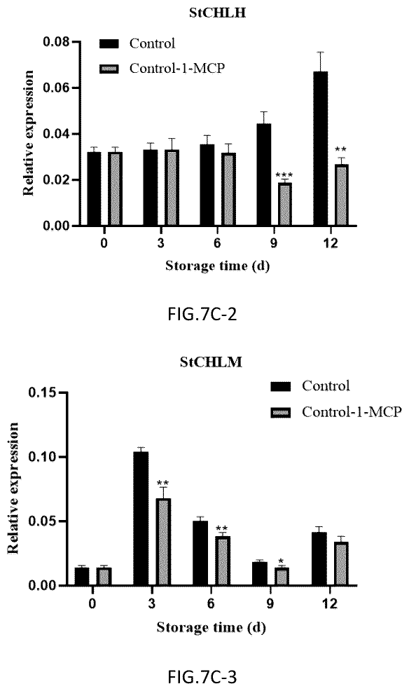

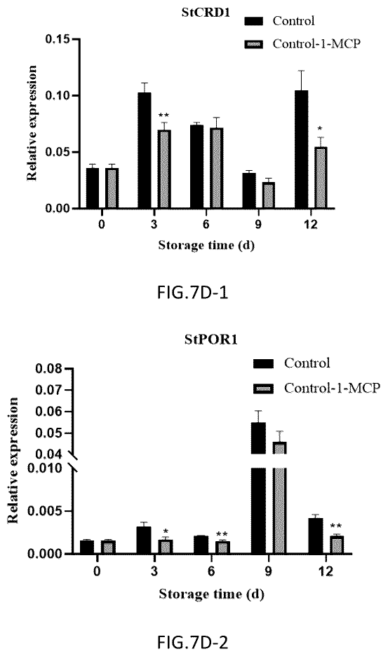

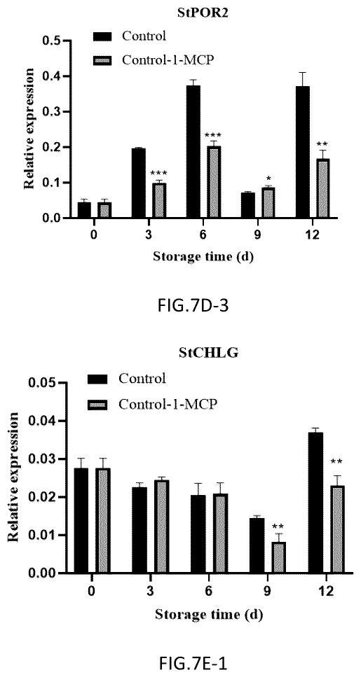

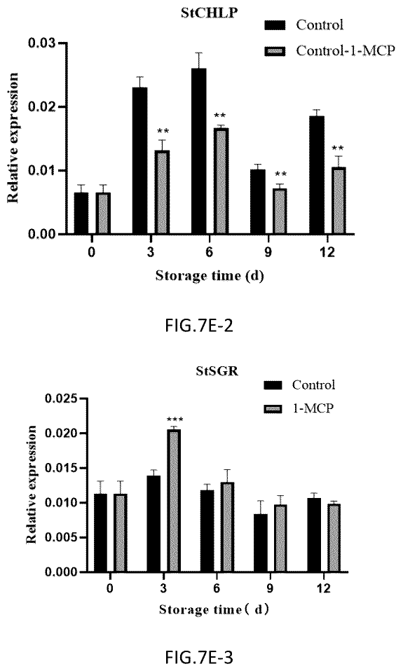

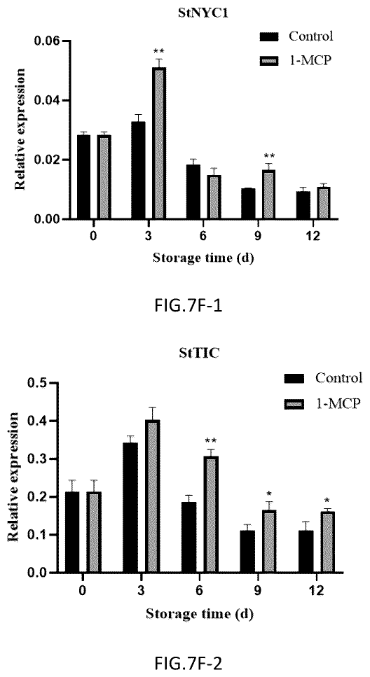

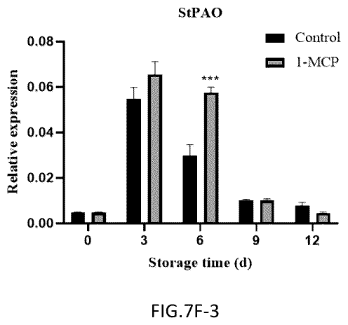

FIGS. 7A-1 through 7A-3, 7B-1 through 7B-3, 7C-1 through 7C-3, 7D-1 through 7D-3, 7E-1 through 7E-3, and 7F-1 through 7F-3 showed the expression amount of key genes in the chlorophyll synthesis pathway and degradation genes. It could be seen through analysis that, during the greening period, the chlorophyll synthesis-related genes in the group treated with 1-MCP were significantly different from those in the control group, and the expression amount was significantly lower than those in the control group; and the expression amount of degradation genes was significantly higher than those in the control group, which revealed another mechanism by which 1-MCP treatment inhibited greening, namely, inhibiting the expression of chlorophyll synthesis-related genes and promoting the expression of chlorophyll degradation-related genes.

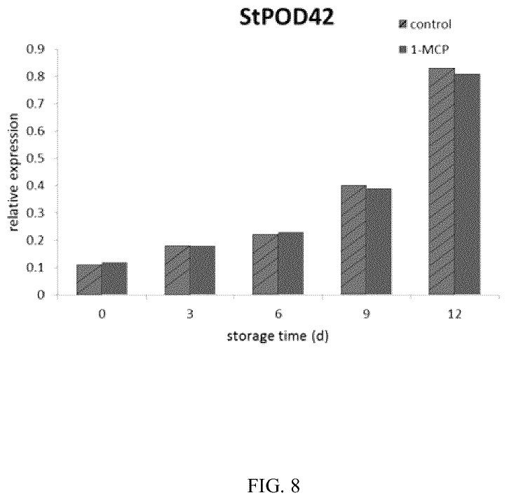

FIG. 8 showed the expression amount of the germination-promoting gene StPOD42. It could be seen through analysis that, 1-MCP treatment did not affect the expression of the germination-promoting gene StPOD42. Combined with the aforementioned conclusions, it could be seen that 1-MCP treatment inhibited greening while not affecting germination, and could achieve no occurrence of greening even when potatoes sprouted.

### Example 3: Test of Fumigation Treatment Reagents

In this example, 1-MCP and NaOH were employed to fumigate potato tubers, and the greening inhibition effects described in Examples 1-2 were obtained. In this example, the selection of reagents in the fumigation treatment was further studied, and the fumigation effects of different reagents were compared to find the reagent that could produce the best effect when fumigated together with 1-MCP.

Three groups of experiments were set up. One group was as described in Example 1, in which potato tubers were fumigated with 1-MCP and NaOH, serving as the control group in this experiment. The difference between an experimental group 1 and the control group was that no NaOH solution was used, but an equal volume of water was used. The difference between an experimental group 2 and the control group was that no NaOH solution was used, but an equal volume of anhydrous ethanol was used.

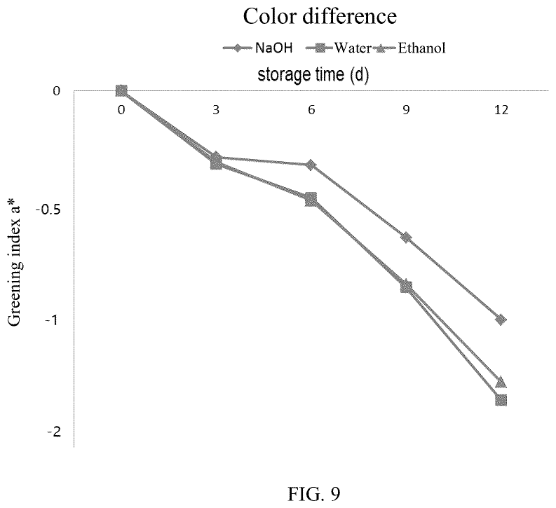

The greening index a* value was determined by the same method as in Example 1. The results of the aforementioned three groups of experiments were shown in FIG. 9. It could be seen from analysis that fumigation with NaOH could significantly improve the effect of 1-MCP in inhibiting greening compared with fumigation with an equal volume of water or ethanol.

### Example 4: Screening for Dosage of 1-MCP

This example employed the method provided in Example 1, and employed 1-MCP and NaOH to fumigate potato tubers, where the dosages of 1-MCP were 1, 5, 10, 15, and 20 mg, respectively. The greening index a* value was determined by the same method as in Example 1. The results after storage for 12 d were shown in Table 1.

TABLE 1
Screening for dosage of 1-MCP

| Dosage of 1-MCP (mg) | Value of greening index a* |
|---|---|
| 1 | −3.2 |
| 5 | −2.1 |
| 10 | −1.2 |
| 15 | −1.8 |
| 20 | −2.6 |

It could be seen according to Table 1 that, the effects of inhibiting potatoes from greening were completely different when potato tubers were fumigated with different contents of 1-MCP and NaOH. When 10 mg of 1-MCP and NaOH were employed to fumigate potato tubers, the effect of inhibiting potatoes from greening could be significantly improved.

The application of the present invention is not limited to this. Various changes and modifications can be made by anyone of skills in the art without departing from the spirit and scope of the present invention, and thus the claimed scope of the present invention should be based on the scope defined by the claims.

1. A method for inhibiting potatoes from greening, comprising treating the potatoes with a reagent containing 1-methylcyclopropene, thereby inhibiting the process of potato greening.

2. The method according to claim 1, wherein the greening is inhibited, thereby inhibiting the production of solanine in the potatoes.

3. The method according to claim 2, wherein the reagent containing 1-methylcyclopropene contains NaOH, and a treatment method is fumigation.

4. The method according to claim 3, wherein 5-10 mg of 1-mcp dry powder is dissolved in 2 milliliters of a 1M NaOH solution to release 1-MCP gas.

5. The method according to claim 4, wherein a weight of the 1-mcp dry powder is 10 milligrams.

6. The method according to claim 5, wherein the potatoes are allowed to be in an environment with 0.01 milligrams of 1-mcp gas/L of gas.

7. The method according to claim 6, wherein the environment is within a controlled atmosphere storage box.

8. The method according to claim 7, wherein the temperature is 25° C.

9. The method according to claim 8, wherein the potatoes sprout first but are not greened or greened slowly.

10. The method according to claim 9, wherein the 1-MCP inhibits the generation of chlorophyll by inhibiting the expression of chlorophyll synthesis-related genes in the potatoes, wherein the genes related to promoting chlorophyll synthesis comprise any one or more of StHEMA, StGSA, StPBGD, StCPO, StPPO, StCHLD, StCHLI, StCHLH, StCHLM, StCRD1, StPOR1, StPOR2, StCHLG, and StCHLP.

11. The method according to claim 10, wherein the 1-MCP reduces chlorophyll by promoting the expression of chlorophyll degradation-related genes in the potatoes, and the chlorophyll degradation-related genes comprise any one or more of StSGR, StNYC1, StTIC, and StPAO.

12. The method according to claim 11, wherein the 1-MCP inhibits the expression of solanine synthesis-related genes in the potatoes, and the solanine synthesis-related genes comprise any one or more of StHMGR, StPSS1, StSQE1, StCAS1, StSSR2, StSSR1, StPGA2, StPGA1, StDOX, StGAME6 (XM_006357819.2), StPGA3, StGAME12, StSGT1, StSGT2, and StSGT3.
